(19) United States
(12) Patent Application Publication
(10) Pub. No.: US 2007/0127444 A1
(43) Pub. Date: Jun. 7, 2007

(54) METHOD OF MANAGING INTERWORKING BETWEEN AT LEAST ONE WIRELESS LOCAL AREA NETWORK AND ONE MOBILE NETWORK, CORRESPONDING MOBILE STATION, SGSN NODE AND TTG GATEWAY

(75) Inventors: Laurence Gras, Bures Sur Yvette (FR); Yacine El Mghazli, Arcueil (FR); Jean-Pierre Rombeaut, Maubeuge (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/557,965

(22) Filed: Nov. 8, 2006

(30) Foreign Application Priority Data
Nov. 9, 2005 (FR) 0553398

(51) Int. Cl. H04L 12/66

(52) U.S. Cl. 370/356; 370/401; 726/14

(57) ABSTRACT

The invention concerns a method of management of interworking between at least one wireless local area network and one mobile network comprising the following steps: in the case of a first handover, from the wireless local area network to the mobile network, of a communication session involving a mobile station, the communication session using, before the first handover, on the one hand an end-to-end tunnel between the mobile station and a TTG gateway and on the other hand a GTP tunnel between the TTG gateway and a GGSN node: replacement of the GTP tunnel between the TTG gateway and the GGSN node by a GTP tunnel between an SGSN node and the GGSN node; clearing down of the end-to-end tunnel between the mobile station and the TTG gateway; in the case of a second handover, from the mobile network to the wireless local area network, of a communication session involving a mobile station, the communication session using, before the second handover, a GTP tunnel between an SGSN node and a GGSN node, the method comprises the following steps: establishment of an end-to-end tunnel between a mobile station and a TTG gateway; replacement of the GTP tunnel between the SGSN node and the GGSN node by a GTP tunnel between the TTG gateway and the GGSN node.

### CROSS-REFERENCE TO RELATED APPLICATIONS

This application is based on French Patent Application No. FR 0553398 filed Nov. 9, 2005, the disclosure of which is hereby incorporated by reference thereto in its entirety, and the priority of which is hereby claimed under 35 U.S.C. § 119.

### BACKGROUND OF THE INVENTION

### Field of the Invention

The field of the invention is that of interworking between networks, and more precisely 3G/WLAN interworking, i.e. interworking between at least one wireless local area network (WLAN) and one 3G mobile network.

By 3G network is meant a 3rd generation mobile network, such as, for example, a GSM/GPRS (Global System for Mobile Communication/General Packet Radio Service) network, a UMTS (Universal Mobile Telecommunication System) network, a CDMA2000 (Code Division Multiple Access 2000) network, etc.

Such 3G/WLAN interworking aims to enable wireless IP access technologies (for example conforming to the WiFi or WiMAX standard) to work with 3G network core infrastructures in order to enable a WLAN user to access packet services via wireless IP access networks.

The technical problem to be solved is the management of location in the context of 3G/WLAN interworking. In other words, it is a question of enabling a mobile user to have heterogeneous access, namely wireless IP access and 3G radio access. The objective is to enable a WLAN user to move from an IP (WLAN) access network to a 3G mobile network and vice-versa without losing continuity of service.

2. Description of the prior art

The 3GPP (3rd Generation Partnership Project) standard provides six scenarios for 3G/WLAN interworking.

Scenario 3 concerns access to 3G packet-switched (PS) services in a WLAN environment. For this purpose, user data traffic uses a tunnel established between the WLAN and the 3G network core via a PDG (Packet Data Gateway).

In one variant of the global architecture for scenario 3 (see appendix F of the 3GPP standardization document TS 23234), a communication session uses an end-to-end tunnel (for example of VPN/Ipsec type) between a mobile station (MS) and a TTG gateway (Tunnel Termination Gateway) and a GTP (GPRS Tunneling Protocol) tunnel between the TTG gateway and a GGSN node (Gateway GPRS Support Node). The advantage of this variant is that it enables the re-use of an existing GGSN node and necessitates no PDG (the TTG gateway contains the functions other than those common to the PDG and the GGSN node).

However, scenario 3 does not maintain continuity of service across the WLAN and 3G radio access networks. In other words, to transfer (“handover”) a call from a first access network to a second (i.e. to move from a WLAN to a 3G network or vice-versa), the current communication session (or service session) via the first access network must imperatively be interrupted and replaced by a new communication session via the second access network.

This is precisely the subject matter of scenario 4, which differs from scenario 3 in that it provides for maintaining continuity of service in this way during a handover between the WLAN and 3G radio access networks.

At present, only the first three of the scenarios cited above are defined in terms of architecture in the 3GPP standard.

### SUMMARY OF THE INVENTION

One objective of the present invention, in at least one embodiment, is to provide a technique enabling implementation of scenario 4 for 3G/WLAN interworking, i.e. enabling continuity of service during transfer (handover) between WLAN and 3G radio access networks.

Another objective of the invention, in at least one embodiment, is to provide a technique enabling continuity of service during transfer (handover) between two WLAN access networks upstream of the same 3G network core for a communication session whereby a mobile session accesses at least one 3G packet-switched service.

Another objective of the invention, in at least one embodiment, is to provide a technique that is simple to implement and of low cost.

A complementary objective of the invention, in at least one embodiment, is to provide a technique enabling the GGSN node to be retained as the anchor point, despite the user (or to be more precise his mobile station) moving from a coverage area of a WLAN to a coverage area of a 3G network or vice-versa.

Another objective of the invention, in at least one embodiment, is to provide a technique necessitating little modification of mobile stations.

In one particular embodiment of the invention, there is proposed a method of managing interworking between at least one wireless local area network and one mobile network. This method comprises the following steps, in the case of a first handover, from the wireless local area network to the mobile network, of a communication session involving a mobile station, said communication session using, before said first handover, on the one hand an end-to-end tunnel between said mobile station and a TTG gateway and on the other hand a GTP tunnel between said TTG gateway and a GGSN node:
replacement of said GTP tunnel between said TTG gateway and said GGSN node by a GTP tunnel between an SGSN node and said GGSN node;
clearing down of said end-to-end tunnel between said mobile station and said TTG gateway.

Accordingly, in this particular embodiment, the invention is based on the idea of considering the TTG gateway, from the point of view of the mobile network core, as if it were an SGSN node (Serving GPRS Support Node). In other words, for the GGSN node, the first handover is reflected in a changeover from a GTP tunnel in which it is involved from the TTG gateway (which the GGSN node sees as a particular SGSN node) to a “standard” SGSN node. This retains the GGSN node as the anchor point on the first handover from the WLAN to the mobile network.

Advantageously, in the case of said first handover, said step of replacement of said GTP tunnel between said TTG gateway and said GGSN node by a GTP tunnel between an SGSN node and said GGSN node comprises the following steps:
the mobile station sends the SGSN node a request to update a routing area comprising a neutral identifier indicating that the mobile station is coming from a wireless local area network;
the SGSN node sends a location server a request for location information relating to said communication session and in return said location server sends the SGSN node an address of said TTG gateway;
the SGSN node sends said TTG gateway a request for context information relating to said communication session and in return said TTG gateway sends the SGSN node said context information;
the SGSN node sends the GGSN node a request for updating of context information relating to said communication session;
the SGSN node and the GGSN node establish a GTP tunnel between them.

It is important to note that the sending by the mobile station of a neutral identifier in the request to update a routing area (to indicate that the mobile station is coming from a WLAN) avoids the WLAN managing the location of the mobile station and providing location information to the mobile station (in order for the latter to provide it to the SGSN node).

To the contrary, in this particular embodiment of the invention, the location of the mobile station is managed by the core of the mobile network: thanks to an exchange of information between the location server (HLR) and the SGSN node, the latter knows from which TTG gateway it can obtain the context information that is necessary for it to establish a GTP tunnel with the GGSN node at the same time as providing continuity of service (the communication session is not interrupted).

Advantageously, in the case of said first handover, said step of clearing down said end-to-end tunnel between said mobile station and said TTG gateway comprises the following steps:
the SGSN node sends the location server a request for updating of the location information relating to said communication session;
the location server sends said TTG gateway a request for clearing down of said end-to-end tunnel between said mobile station and said TTG gateway.

Advantageously, in the case of said first handover, said step of clearing down of said end-to-end tunnel between said mobile station and said TTG gateway further comprises the following steps:
said TTG gateway sends the location server a message of confirmation of said clearing down;
the location server sends the SGSN node a message of confirmation of said updating of the location information;
the SGSN node sends the mobile station a message of acceptance of the updating of the routing area.

In an advantageous embodiment of the invention said method comprises the following steps, in the case of a second handover, from the mobile network to the wireless local area network, of a communication session involving a mobile station, said communication session using, before said second handover, a GTP tunnel between an SGSN node and a GGSN node:
establishing an end-to-end tunnel between a mobile station and a TTG gateway;
replacement of said GTP tunnel between said SGSN node and said GGSN node by a GTP tunnel between said TTG gateway and said GGSN node.

Accordingly, in this particular embodiment, the invention is again based on the idea of considering the TTG gateway, from the point of view of the mobile network core, as if it were an SGSN node. In other words, for the GGSN node, the second handover is reflected by a changeover of a GTP tunnel in which it is involved from a “standard” SGSN node to the TTG gateway (which it sees as a particular SGSN node). Here again, the GGSN node is retained as the anchor point on the second handover from the mobile network to the WLAN.

Advantageously, in the case of said second handover, said step of establishment of an end-to-end tunnel between said mobile station and said TTG gateway comprises the following steps:
the mobile station obtains an address of the TTG gateway;
the mobile station sends a request for the establishment of an end-to-end tunnel to the TTG gateway;
the TTG gateway obtains from an AAA server authorization and authentication information for establishing an end-to-end tunnel between said mobile station and said TTG gateway.

Advantageously, in the case of said second handover, said step of replacement of said GTP tunnel between said SGSN node and said GGSN node with a GTP tunnel between said TTG gateway and said GGSN node comprises the following steps:
the TTG gateway sends the location server a request for location information relating to said communication session and in return said location server sends the TTG gateway an address of said SGSN node;
the TTG gateway sends said SGSN node a request for context information relating to said communication session and in return said SGSN node sends the TTG gateway said context information;
the TTG gateway sends the GGSN node a request for updating of context information relating to said communication session;
the TTG gateway and the GGSN node establish a GTP tunnel between them.

Advantageously, in the case of said second handover, said step of establishment of an end-to-end tunnel between said mobile station and said TTG gateway further comprises the following steps:
the TTG gateway sends the location server a request for updating of the location information relating to said communication session;
the location server sends the SGSN node a request for suppression of location information relating to said communication session;
the SGSN node sends the location server a message of confirmation of said suppression;
the location server sends the TTG gateway a message of confirmation of said updating of location information;
the TTG gateway sends the mobile station a message of acceptance of the establishment of an end-to-end tunnel.

In one advantageous embodiment of the invention, in the case of a third handover, from a first wireless local area network to a second wireless local area network of a communication session involving a mobile station, said communication session using, before said third handover, on the one hand a first end-to-end tunnel between said mobile station and a TTG gateway and on the other hand a GTP tunnel between said TTG gateway and a GGSN node;
replacement of said first end-to-end tunnel between said mobile station and said TTG gateway with a second end-to-end tunnel between said mobile station and said TTG gateway;
conservation of said GTP tunnel between said TTG gateway and said GGSN node.

Because it is the same TTG gateway that is used before and after the third handover, the same GTP tunnel between that gateway and the GGSN node may be retained. Here again, the GGSN node is retained as the anchor point on the third handover from the mobile network to the WLAN.

Advantageously, in the case of said third handover, said step of replacement of said first end-to-end tunnel by said second end-to-end tunnel comprises the following steps:
the mobile station obtains an address of the TTG gateway;
the mobile station sends a request for the establishment of a second end-to-end tunnel to the TTG gateway;
the TTG gateway obtains from an AAA server authorization and authentication information relating to said communication session and enabling the establishment of a second end-to-end tunnel between said mobile station and said TTG gateway;
the TTG gateway clears down said first end-to-end tunnel and establishes said second end-to-end tunnel.

Advantageously, in the case of said third handover, said step of replacement of said first end-to-end tunnel by said second end-to-end tunnel further comprises the following steps:
the TTG gateway sends the AAA server a request for the updating of the authorization and authentication information relating to said communication session;
the AAA server sends the TTG gateway a message of confirmation of said updating of the authorization and authentication information;
the TTG gateway sends the mobile station a message of acceptance of the establishment of a second end-to-end tunnel.

One embodiment of the invention concerns a mobile station enabling the implementation of a method of management of interworking between at least one wireless local area network and one mobile network. The mobile station comprises, to enable a first handover, from the wireless local area network to the mobile network, of a communication session involving a mobile station and using, before said first handover, on the one hand an end-to-end tunnel between said mobile station and a TTG gateway and on the other hand a GTP tunnel between said TTG gateway and said GGSN node:
means for sending an SGSN node a request for updating of a routing area, with a neutral identifier indicating that said mobile station is coming from a wireless local area network.

More generally, the mobile station according to the invention comprises means for implementing the method of managing 3G/WLAN interworking described hereinabove (in any of its various embodiments).

One embodiment of the invention concerns an SGSN node enabling the implementation of a method of management of interworking between at least one wireless local area network and one mobile network. The SGSN node comprises, to enable a first handover, from the wireless local area network to the mobile network, of a communication session involving a mobile station and using, before said first handover, on the one hand an end-to-end tunnel between said mobile station and a TTG gateway and on the other hand a GTP tunnel between said TTG gateway and said GGSN node:
means for reception of a request for updating of a routing area sent by said mobile station and comprising a neutral identifier indicating that the mobile station is coming from a wireless local area network;
means for sending a location server a request for location information relating to said communication session and means for reception in return of an address of said TTG gateway;
means for sending said TTG gateway a request for context information relating to said communication session and means for reception in return of said context information;
means for sending the GGSN node a request for updating of context information relating to said communication session;
means for establishment of a GTP tunnel between the SGSN node and the GGSN node.

More generally, the SGSN node according to the invention comprises means for implementing the method of managing 3G/WLAN interworking described hereinabove (in any of its various embodiments).

Advantageously, said SGSN node further comprises, to enable a second handover, from the mobile network to the wireless local area network, of a communication session involving a mobile station (MS), said communication session using, before said second handover, a GTP tunnel between an SGSN node and a GGSN node:
means for reception of a request for context information relating to said communication session sent by a TTG gateway;
means for sending of said context information to said TTG gateway.

One embodiment of the invention relates to a TTG gateway enabling the implementation of a method of management of interworking between at least one wireless local area network and one mobile network. The TTG gateway comprises, to enable a first handover, from the wireless local area network to the mobile network, of a communication session involving a mobile station (MS) and using, before said first handover, on the one hand an end-to-end tunnel between said mobile station and said TTG gateway and on the other hand a GTP tunnel between said TTG gateway and said GGSN node:
means for reception of a request for context information relating to said communication session sent by an SGSN node;
means for sending of said context information to the SGSN node.

More generally, the TTG gateway according to the invention comprises means for implementing the method of managing 3G/WLAN interworking described hereinabove (in any of its various embodiments).

Advantageously, said TTG gateway further comprises, to enable a second handover, from the mobile network to the wireless local area network, of a communication session involving a mobile station, said communication session using, before said second handover, a GTP tunnel between an SGSN node and a GGSN node:
means for sending a location server a request for location information relating to said communication session and means for reception in return of an address of said SGSN node;
means for sending said SGSN node a request for context information relating to said communication session, and means for reception in return of said context information;
means for sending the GGSN node a request for updating of context information relating to said communication session;
means for the establishment of a GTP tunnel between the TTG gateway and the GGSN node.

Advantageously, said TTG gateway further comprises, to enable a third handover, from a first wireless local area network to a second wireless local area network, of a communication session involving a mobile station, said communication session using, before said third handover, on the one hand a first end-to-end tunnel between said mobile station and said TTG gateway and on the other hand a GTP tunnel between said TTG gateway and a GGSN node:
means for reception of a request for establishment of a second end-to-end tunnel sent by the mobile station;
means for obtaining from an AAA server authorization and authentication information relating to said communication session and enabling the establishment of a second end-to-end tunnel between said mobile station and said TTG gateway;
means for clearing down of said first end-to-end tunnel;
means for establishment of said second end-to-end tunnel.

Other features and advantages of embodiments of the invention will become apparent on reading the following description of a preferred embodiment of the invention given by way of illustrative and nonlimiting example (not all embodiments of the invention are limited to the features and advantages of this preferred embodiment), and the appended drawings.

### BRIEF DESCRIPTION OF THE DRAWINGS

FIG. 1 shows a block diagram of one particular embodiment of a 3G/WLAN interworking system according to the invention.

FIG. 2 shows a first communication session handover, from the WLAN to the 3G mobile network.

FIG. 3 is a diagram that shows one example of the exchange of messages between various entities of the system in the case of the first handover shown in FIG. 2.

FIG. 4 shows a second communication session handover, from the 3G mobile network to the WLAN.

FIG. 5 is a diagram that shows one example of the exchange of messages between various entities of the system in the case of the second handover shown in FIG. 4.

FIG. 6 shows a third communication session handover, from a first WLAN to a second WLAN.

FIG. 7 is a diagram that shows one example of the exchange of messages between various entities of the system in the case of the third handover shown in FIG. 6.

### DETAILED DESCRIPTION OF THE PREFERRED EMBODIMENT

In all the figures of the present document, identical elements and steps are designated by the same reference number.

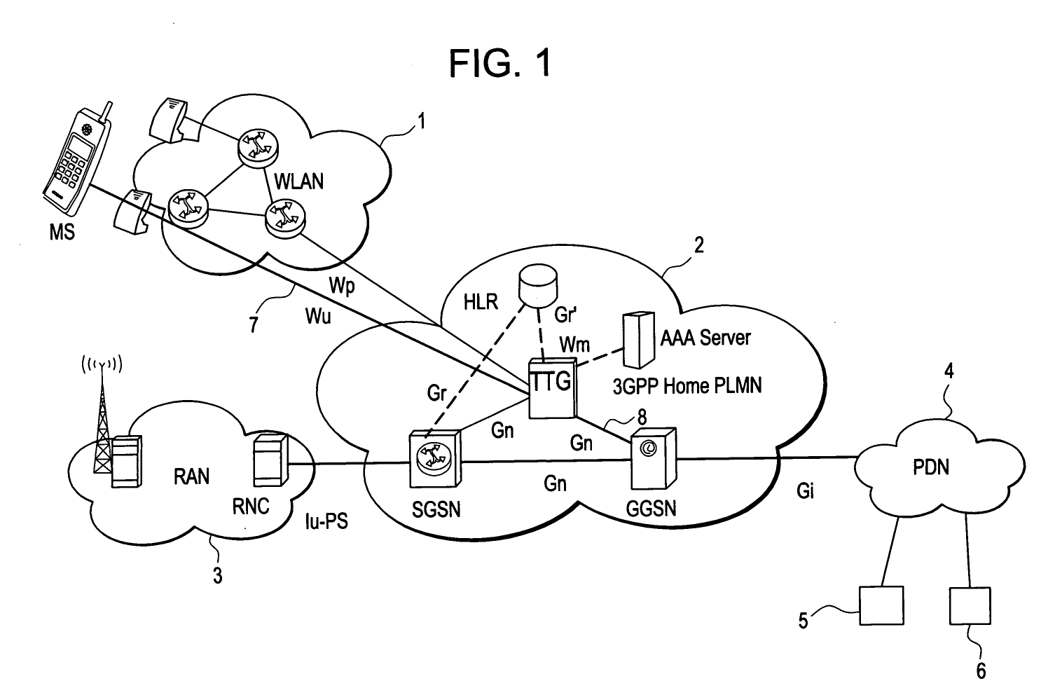

FIG. 1 shows one particular embodiment of a 3G/WLAN interworking system according to the invention for implementing the method of managing 3G/WLAN interworking in accordance with one particular embodiment of the invention.

It is assumed that a mobile station (MS) wishes to access one or more 3GPP packet-switched (3GPP PS) services offered by one or more application servers 5, 6 connected to a PDN (Public Data Network) 4.

It is also assumed that this mobile station is of the hybrid access type, in the sense that it can use:
either the radio access network (RAN) 3 and the core 2 of a mobile network 3G (also referred to as the 3GPP Home PLMN). In this case, in conformance with the 3GPP standards, a communication session uses a GTP tunnel (no reference number in FIG. 1) between an SGSN node and a GGSN node (with an interface Gn);
or a WLAN 1, which serves as an access network, and the core 2 of the 3G mobile network cited above. In this case, and in the context defined in appendix F of the 3GPP standardization document TS 23234, a communication session uses an end-to-end tunnel 7 between the mobile station MS and a TTG gateway (with an interface Wu), and a GTP tunnel 8 between the TTG gateway and the GGSN node (with an interface Gn′).

In the conventional way, the SGSN node is connected to a location HLR server (Home Location Register), with an interface Gr. The TTG gateway is connected to an AAA (Authentication, Authorization & Account) server, with an interface Wm.

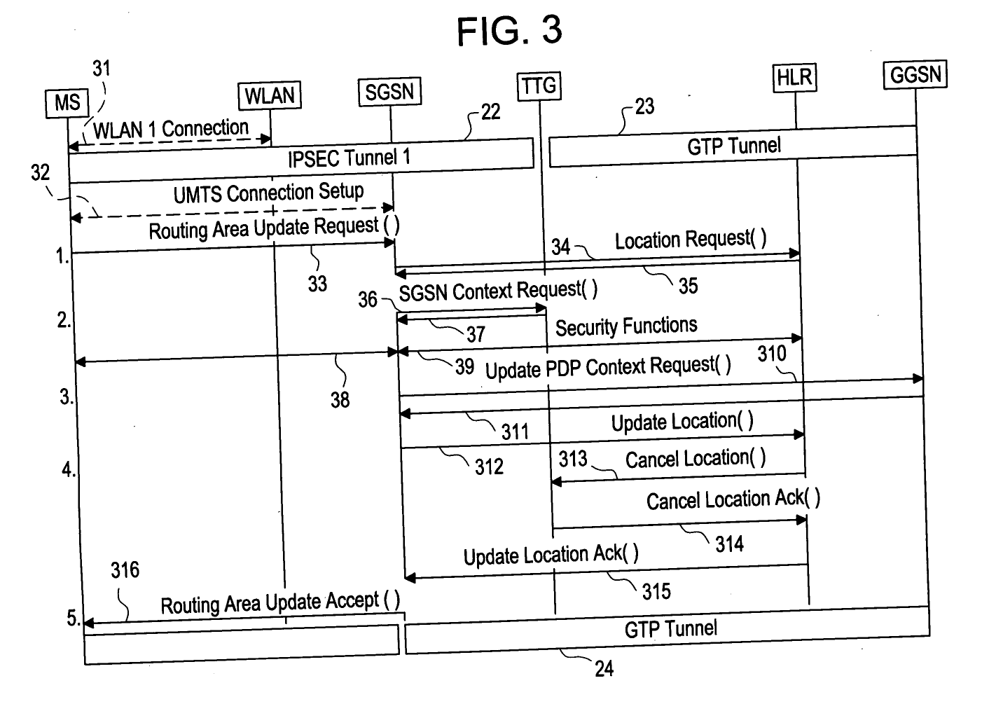

In one particular embodiment of the invention, the TTG gateway is also connected to the SGSN node, with an interface Gn, and to the HLR server, with an interface Gr′. The use of these new connections is described in detail hereinafter with reference to FIGS. 3, 5 and 7, corresponding to three distinct types of communication session handover involving the mobile station MS.

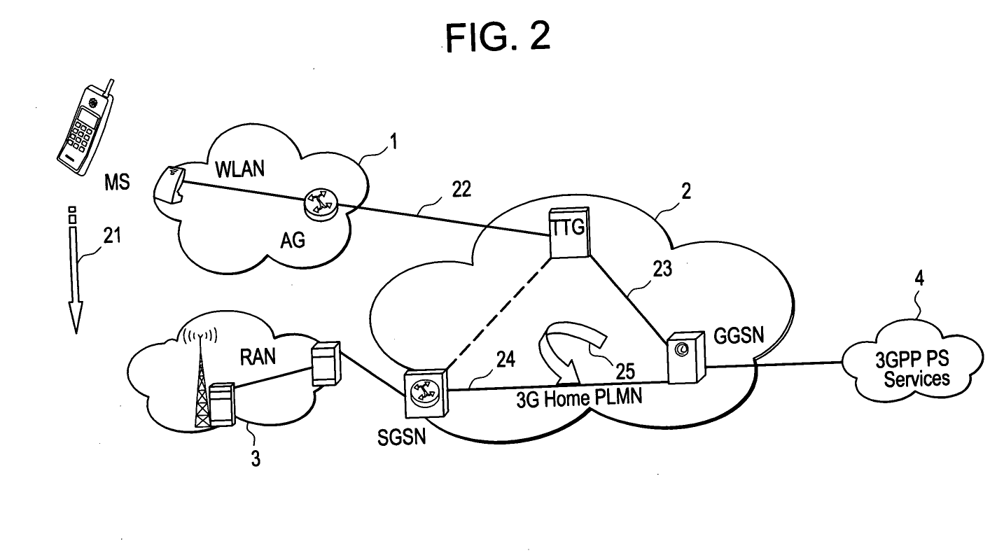

FIG. 2 shows a first communication session handover, from the WLAN to the 3G mobile network, in accordance with one particular embodiment of the method according to the invention.

It is assumed that the mobile station MS moves (as shown by the arrow 21) from the coverage area of the WLAN 1 to that of the 3G mobile network 3.

It is also assumed that, before the first handover, the communication session uses an end-to-end tunnel 22 between the mobile station MS and the TTG gateway and a first GTP tunnel 23 between the TTG gateway and the GGSN node.

To effect this first handover, one particular embodiment of the method of the invention comprises the following steps:
replacing the first GTP tunnel 23 between the TTG gateway and the GGSN node by a second GTP tunnel 24 between the SGSN node and the GGSN node (this replacement is indicated by the arrow 25);
clearing down the end-to-end tunnel 22 between the mobile station MS and the TTG gateway.

There is described next, with reference to FIG. 3, a diagram that shows one example of the exchange of messages between different entities of the system to effect the first handover shown in FIG. 2.

The entities concerned, which have already been described hereinabove, are: the mobile station MS, the WLAN, the SGSN node, the TTG gateway, the HLR server and the GGSN node.

Before the first transfer, a communication session involving the mobile station MS uses an end-to-end tunnel 22 between the mobile station MS and the TTG gateway (relying in particular on a connection 31 between the mobile station MS and the WLAN) and a first GTP tunnel 23 between the TTG gateway and the GGSN node.

After being moved, the mobile station MS sets up a UMTS connection 32 to the SGSN node.

The mobile station then sends the SGSN node a routing area update request 33 comprising a neutral routing area identification (RAI) indicating that the mobile station is coming from a WLAN. This neutral RAI value is reserved for all the WLAN coverage areas but does not define any information as to the location of the mobile station MS.

The SGSN node sends the HLR server a location request 34 seeking location information relating to the communication session for identifying the TTG gateway previously involved in the communication session. In return (35), the HLR server sends the SGSN node an address of the TTG gateway.

The SGSN node sends the TTG gateway a packet data protocol (PDP) context information request 36 relating to the communication session (SGSN node Context Request). In return (37), the TTG gateway sends the SGSN node the requested PDP context information (SGSN node Context Response). The security functions may then be executed (38, 39).

The SGSN node sends the GGSN node an update PDP context request 310 relating to the communication session. The GGSN node updates the PDP context fields of the GTP (GPRS Tunneling Protocol) routing table, replacing the IP address of the TTG gateway with the IP address of the SGSN node. The GGSN node returns an update PDP context response 311 confirming the updating of context information. The SGSN node and the GGSN node establish a new (second) GTP tunnel 24 between them.

The SGSN node informs the HLR server of the change of location by sending it an Update Location request 312 to update the location information relating to the communication session.

The HLR server requests the clearing down of the end-to-end tunnel 22 between the mobile station MS and the TTG by sending the TTG a Cancel Location message 313. TTG gateway After the end-to-end tunnel 22 between the mobile station MS and the TTG gateway has been cleared down, the TTG gateway sends the HLR a Cancel Location Ack message 314 confirming the clearing down. The HLR server then sends the SGSN node an Update Location Ack message 315 confirming the updating of the location information. Finally, the SGSN node sends the mobile station MS a Routing Area Update Accept message 316 accepting the updating of the routing area.

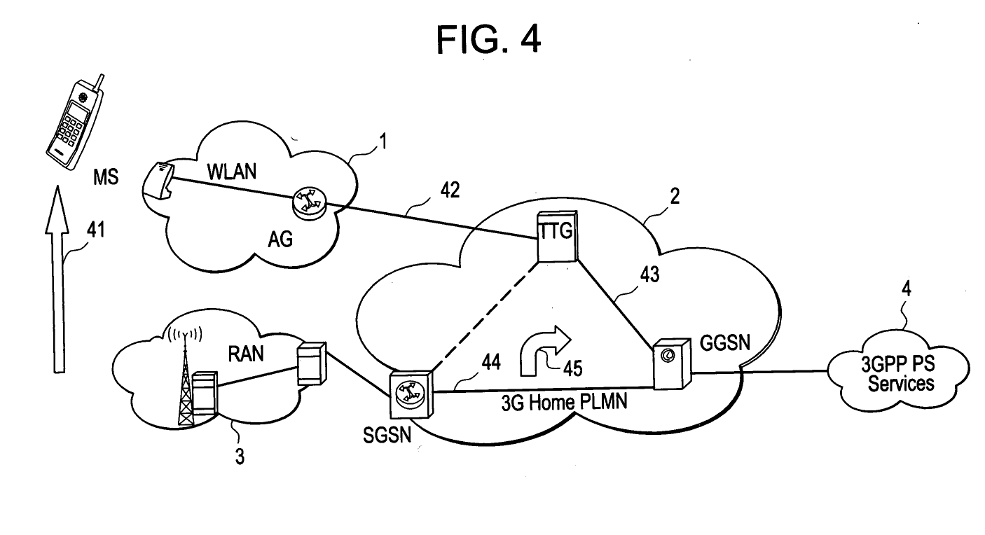

FIG. 4 shows a second communication session handover, from the 3G mobile network to the WLAN, in accordance with one particular embodiment of the method according to the invention.

It is assumed that the mobile station MS moves (as indicated by the arrow 41) from the coverage area of the 3G mobile network 3 to that of the WLAN 1.

It is also assumed that, before the second handover, the communication session uses a first GTP tunnel 44 between the SGSN node and the GGSN node.

To effect this second handover, one particular embodiment of the method of the invention comprises the following steps:
establishing an end-to-end tunnel 42 between the mobile station and the TTG gateway;
replacing the first GTP tunnel 44 between the SGSN node and the GGSN node by a second GTP tunnel 43 between the TTG gateway and the GGSN node (this replacement is indicated by the arrow 45).

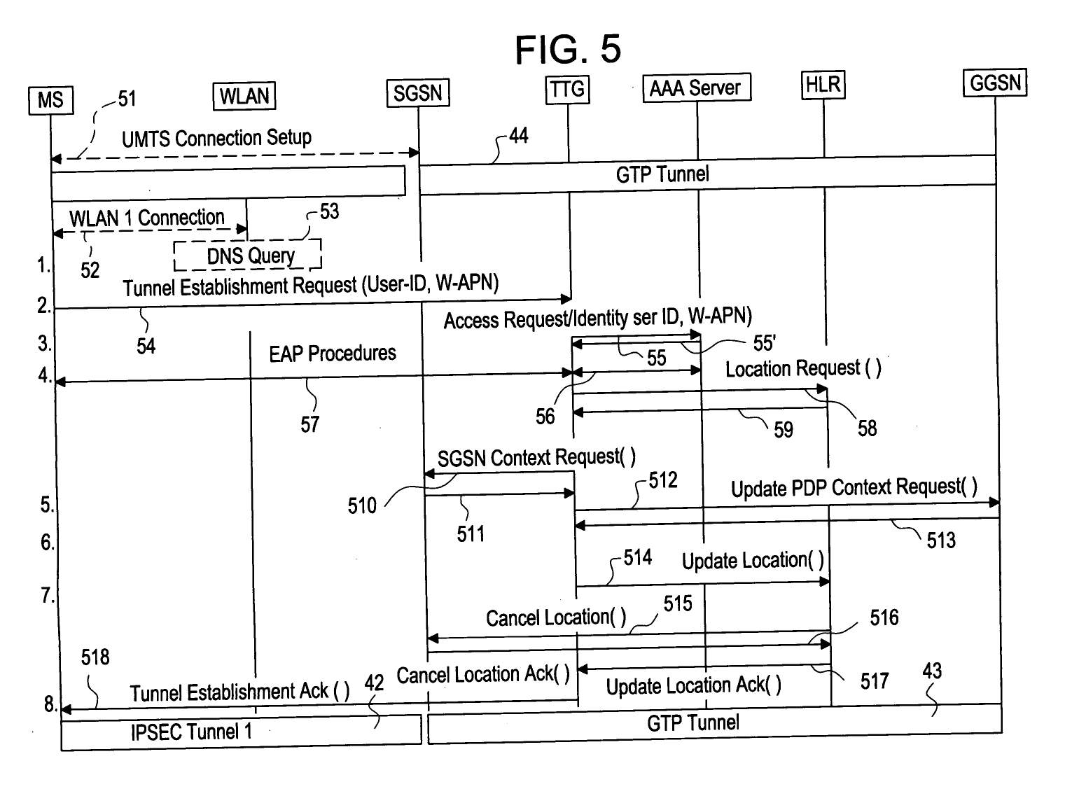

There is described next, with reference to FIG. 5, a diagram that shows one example of the exchange of messages between different entities of the system for effecting the second handover shown in FIG. 4.

The entities concerned, which have already been described hereinabove, are: the mobile station MS, the WLAN, the SGSN node, the TTG gateway, the AAA server, the HLR server and the GGSN node.

Before the second handover, the mobile station MS has set up a UMTS connection 51 to the SGSN node. Furthermore, a communication session involving the mobile station uses a GTP tunnel 44 between the SGSN node and the GGSN node.

After it has been moved, the mobile station MS sets up a connection 52 to the WLAN.

The mobile station MS then effects a DNS (Domain Name System) request 53, in order to retrieve the IP address of the far end of the future GTP tunnel, i.e. the TTG gateway.

After it has obtained the IP address of the TTG gateway, the mobile station MS sends a Tunnel Establishment Request (User-ID, W-APN) 54 to the TTG gateway requesting the establishing of an end-to-end tunnel.

After reception of the above request 54, the TTG gateway contacts the AAA server (55, 55′) in order to obtain authorization and authentication information enabling launching of the EAP (Extensible Authentication Protocol) procedures 56, 57 and the establishing of an end-to-end tunnel 42 between the mobile station MS and the TTG gateway.

The TTG gateway sends the HLR server a Location Request 58 requesting location information relating to the communication session. If the session is open, the HLR server in return (59) sends the TTG gateway the IP address of the SGSN node.

The TTG gateway sends the SGSN node an SGSN node Context Request 510 requesting PDP context information relating to the communication session. In return (511), the SGSN node sends the TTG gateway the requested PDP context information (SGSN node Context Response) 511.

The TTG gateway sends the GGSN node an Update PDP Context Request 512 requesting updating of context information relating to the communication session.

The GGSN node updates the PDP context fields of the GTP (GPRS Tunneling Protocol) routing table, replacing the IP address of the SGSN node with the IP address of the TTG gateway. The GGSN node returns an Update PDP Context Response 513 confirming the updating of context information. The TTG gateway and the GGSN node establish a new (second) GTP tunnel 43 between them.

The TTG gateway sends the HLR server an Update Location request 514 requesting updating of the location information relating to the communication session. The HLR server sends the SGSN node a Cancel Location request 515 requesting cancellation of location information relating to the communication session. The SGSN node sends the HLR server a Cancel Location Ack message 516 confirming the cancellation. The HLR server sends the TTG gateway an Update Location Ack message 517 confirming the updating of the location information.

Finally, the TTG gateway sends the mobile station MS a Tunnel Establishment Ack message 518 accepting the setting up of an end-to-end tunnel.

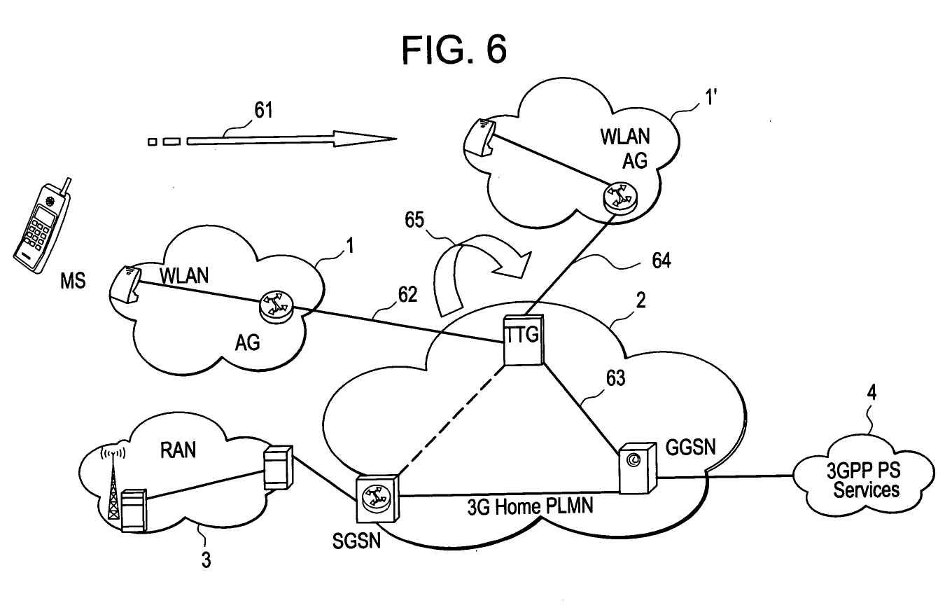

FIG. 6 shows a third communication session handover, from a first WLAN 1 to a second WLAN 1′, in accordance with one particular embodiment of the method according to the invention.

It is assumed that the mobile station MS moves (as indicated by the arrow referenced 61) from the coverage area of the first WLAN 1 to that of the second WLAN 1′.

It is also assumed that, before the third handover, the communication session uses a first end-to-end tunnel 62 between the mobile station MS and the TTG gateway and a GTP tunnel 63 between the TTG gateway and the GGSN node.

To effect this third handover, one particular embodiment of the method of the invention comprises the following steps:
replacing the first end-to-end tunnel 62 between the mobile station MS and the TTG gateway with a second end-to-end tunnel 64 between the mobile station MS and the TTG gateway (this replacement is indicated by the arrow 65);
conserving the GTP tunnel 63 between the TTG gateway and the GGSN node.

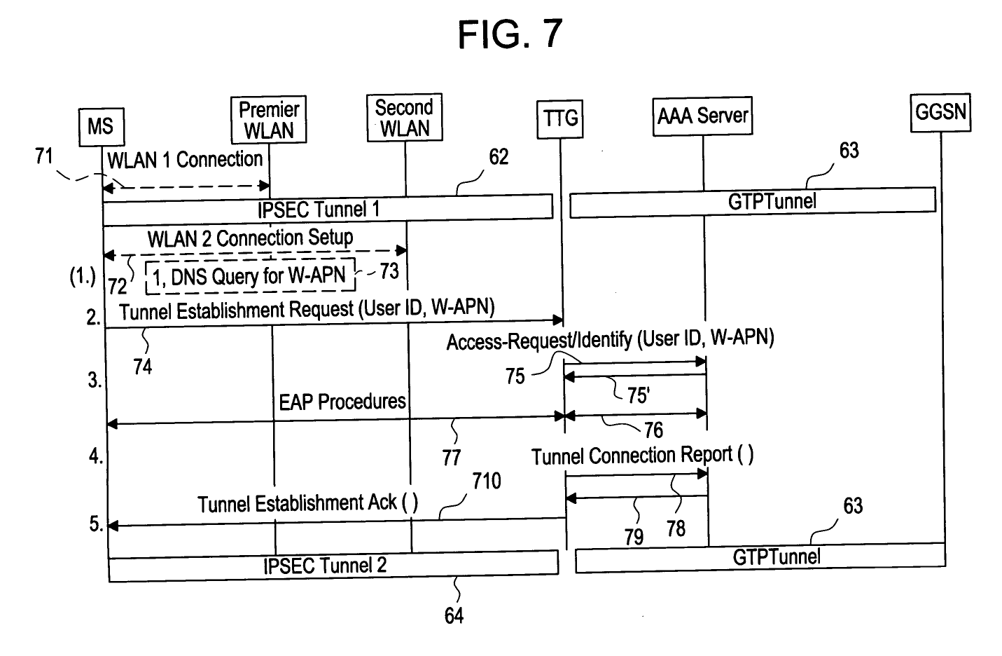

There is described next, with reference to FIG. 7, a diagram that shows one example of the exchange of messages between different entities of the system to effect the third handover shown in FIG. 6.

The entities concerned, which have already been described hereinabove, are: the mobile station MS, the first WLAN, the second WLAN, the TTG gateway, the AAA server and the GGSN node.

Before the third handover, a communication session involving the mobile station uses an end-to-end tunnel 62 between the mobile station MS and the TTG gateway (relying in particular on a connection 71 between the mobile station MS and the first WLAN) and a GTP tunnel 63 between the TTG gateway and the GGSN node.

After it has been moved, the mobile station MS sets up a connection 72 to the second WLAN.

The mobile station MS then effects a DNS (Domain Name System) request 73, in order to retrieve the IP address of the far end of the GTP tunnel 63, i.e. the TTG gateway.

After it has obtained the IP address of the TTG gateway, the mobile station MS sends a Tunnel Establishment Request (User-ID, W-APN) 74 to the TTG gateway to request the establishment of an end-to-end tunnel.

After reception of the above request 74, the TTG gateway contacts the AAA server (75, 75′) in order to obtain authorization and authentication information enabling launching of the EAP (Extensible Authentication Protocol) procedures 76, 77. The AAA server verifies that the session is already open and if this is the case the TTG gateway clears down the first end-to-end tunnel 62 and establishes a second end-to-end tunnel 64.

The TTG gateway sends the AAA server a Tunnel Connection Report request 78 requesting updating of the authorization and authentication information relating to the communication session. The AAA server sends the TTG gateway a message 79 confirming updating of the authorization and authentication information.

Finally, the TTG gateway sends the mobile station a Tunnel Establishment Ack message 710 accepting the establishing of a second end-to-end tunnel.

There is claimed:

1. A method of managing interworking between at least one wireless local area network and one mobile network, comprising the following steps, in the case of a first handover, from the wireless local area network to the mobile network, of a communication session involving a mobile station, said communication session using, before said first handover, on the one hand an end-to-end tunnel between said mobile station and a TTG gateway and on the other hand a GTP tunnel between said TTG gateway and a GGSN node:
replacement of said GTP tunnel between said TTG gateway and said GGSN node by a GTP tunnel between an SGSN node and said GGSN node;
clearing down of said end-to-end tunnel between said mobile station and said TTG gateway.

2. The method according to claim 1, wherein, in the case of said first handover, said step of replacement of said GTP tunnel between said TTG gateway and said GGSN node by a GTP tunnel between an SGSN node and said GGSN node comprises the following steps:
the mobile station sends the SGSN node a request to update a routing area comprising a neutral identifier indicating that the mobile station is coming from a wireless local area network;
the SGSN node sends a location server a request for location information relating to said communication session and in return said location server sends the SGSN node an address of said TTG gateway;
the SGSN node sends said TTG gateway a request for context information relating to said communication session and in return said TTG gateway sends the SGSN node said context information;
the SGSN node sends the GGSN node a request for updating of context information relating to said communication session;
the SGSN node and the GGSN node establish a GTP tunnel between them.

3. The method according to claim 1, wherein, in the case of said first handover, said step of clearing down said end-to-end tunnel between said mobile station and said TTG gateway comprises the following steps:
the SGSN node sends the location server a request for updating of the location information relating to said communication session;
the location server sends said TTG gateway a request for clearing down of said end-to-end tunnel between said mobile station and said TTG gateway.

4. The method according to claim 3, wherein, in the case of said first handover, said step of clearing down of said end-to-end tunnel between said mobile station and said TTG gateway further comprises the following steps:
said TTG gateway sends the location server a message of confirmation of said clearing down;
the location server sends the SGSN node a message of confirmation of said updating of the location information;
the SGSN node sends the mobile station a message of acceptance of the updating of the routing area.

5. The method according to claim 1, comprising the following steps, in the case of a second handover, from the mobile network to the wireless local area network, of a communication session involving a mobile station, said communication session using, before said second handover, a GTP tunnel between an SGSN node and a GGSN node:
establishing an end-to-end tunnel between a mobile station and a TTG gateway;
replacement of said GTP tunnel between said SGSN node and said GGSN node by a GTP tunnel between said TTG gateway and said GGSN node.

6. The method according to claim 5, wherein, in the case of said second handover, said step of establishment of an end-to-end tunnel between said mobile station and said TTG gateway comprises the following steps:
the mobile station obtains an address of the TTG gateway;
the mobile station sends a request for the establishment of an end-to-end tunnel to the TTG gateway;
the TTG gateway obtains from an AAA server authorization and authentication information for establishing an end-to-end tunnel between said mobile station and said TTG gateway.

7. The method according to claim 5, wherein, in the case of said second handover, said step of replacement of said GTP tunnel between said SGSN node and said GGSN node with a GTP tunnel between said TTG gateway and said GGSN node comprises the following steps:
the TTG gateway sends the location server a request for location information relating to said communication session and in return said location server sends the TTG gateway an address of said SGSN node;
the TTG gateway sends said SGSN node a request for context information relating to said communication session and in return said SGSN node sends the TTG gateway said context information;
the TTG gateway sends the GGSN node a request for updating of context information relating to said communication session;
the TTG gateway and the GGSN node establish a GTP tunnel between them.

8. The method according to claim 5, wherein, in the case of said second handover, said step of establishment of an end-to-end tunnel between said mobile station and said TTG gateway further comprises the following steps:
the TTG gateway sends the location server a request for updating of the location information relating to said communication session;
the location server sends the SGSN node a request for suppression of location information relating to said communication session;
the SGSN node sends the location server a message of confirmation of said suppression;
the location server sends the TTG gateway a message of confirmation of said updating of location information;
the TTG gateway sends the mobile station a message of acceptance of the establishment of an end-to-end tunnel.

9. The method according to claim 1, comprising the following steps, in the case of a third handover, from a first wireless local area network to a second wireless local area network of a communication session involving a mobile station, said communication session using, before said third handover, on the one hand a first end-to-end tunnel between said mobile station and a TTG gateway and on the other hand a GTP tunnel between said TTG gateway and a GGSN node;
replacement of said first end-to-end tunnel between said mobile station and said TTG gateway with a second end-to-end tunnel between said mobile station and said TTG gateway;
conservation of said GTP tunnel between said TTG gateway and said GGSN node.

10. The method according to claim 9, wherein, in the case of said third handover, said step of replacement of said first end-to-end tunnel by said second end-to-end tunnel comprises the following steps:
the mobile station obtains an address of the;
the mobile station sends a request for the establishment of a second end-to-end tunnel to the TTG gateway;
the TTG gateway obtains from an AAA server authorization and authentication information relating to said communication session and enabling the establishment of a second end-to-end tunnel between said mobile station and said TTG gateway;
the TTG gateway clears down said first end-to-end tunnel and establishes said second end-to-end tunnel.

11. The method according to claim 10, wherein, in the case of said third handover, said step of replacement of said first end-to-end tunnel by said second end-to-end tunnel further comprises the following steps:
the TTG gateway sends the AAA server a request for the updating of the authorization and authentication information relating to said communication session;
the AAA server sends the TTG gateway a message of confirmation of said updating of the authorization and authentication information;
the TTG gateway sends the mobile station a message of acceptance of the establishment of a second end-to-end tunnel.

12. A mobile station enabling the implementation of a method of management of interworking between at least one wireless local area network and one mobile network, comprising, to enable a first handover, from the wireless local area network to the mobile network, of a communication session involving a mobile station and using, before said first handover, on the one hand an end-to-end tunnel between said mobile station and a TTG gateway and on the other hand a GTP tunnel between said TTG gateway and said GGSN node:
means for sending an SGSN node a request for updating of a routing area, with a neutral identifier indicating that said mobile station is coming from a wireless local area network.

13. An SGSN node enabling the implementation of a method of management of interworking between at least one wireless local area network and one mobile network, comprising, to enable a first handover, from the wireless local area network to the mobile network, of a communication session involving a mobile station and using, before said first handover, on the one hand an end-to-end tunnel between said mobile station and a TTG gateway and on the other hand a GTP tunnel between said TTG gateway and said GGSN node:
means for reception of a request for updating of a routing area sent by said mobile station and comprising a neutral identifier indicating that the mobile station is coming from a wireless local area network;
means for sending a location server a request for location information relating to said communication session and means for reception in return of an address of said TTG gateway;
means for sending said TTG gateway a request for context information relating to said communication session and means for reception in return of said context information;
means for sending the GGSN node a request for updating of context information relating to said communication session;
means for establishment of a GTP tunnel between the SGSN node and the GGSN node.

14. The SGSN node according to claim 13, further comprising, to enable a second handover, from the mobile network to the wireless local area network, of a communication session involving a mobile station, said communication session using, before said second handover, a GTP tunnel between an SGSN node and a GGSN node:
means for reception of a request for context information relating to said communication session sent by a TTG gateway;
means for sending of said context information to said TTG gateway.

15. A TTG gateway enabling the implementation of a method of management of interworking between at least one wireless local area network and one mobile network, comprising, to enable a first handover, from the wireless local area network to the mobile network, of a communication session involving a mobile station and using, before said first handover, on the one hand an end-to-end tunnel between said mobile station and said TTG gateway and on the other hand a GTP tunnel between said TTG gateway and said GGSN node:
means for reception of a request for context information relating to said communication session sent by an SGSN node;
means for sending of said context information to the SGSN node.

16. The TTG gateway according to claim 15, further comprising, to enable a second handover, from the mobile network to the wireless local area network, of a communication session involving a mobile station, said communication session using, before said second handover, a GTP tunnel between an SGSN node and a GGSN node:
means for sending a location server a request for location information relating to said communication session and means for reception in return of an address of said SGSN node;
means for sending said SGSN node a request for context information relating to said communication session, and means for reception in return of said context information;
means for sending the GGSN node a request for updating of context information relating to said communication session;
means for the establishment of a GTP tunnel between the TTG gateway and the GGSN node.

17. The TTG gateway according to claim 15, further comprising, to enable a third handover, from a first wireless local area network to a second wireless local area network, of a communication session involving a mobile station, said communication session using, before said third handover, on the one hand a first end-to-end tunnel between said mobile station and said TTG gateway and on the other hand a GTP tunnel between said TTG gateway and a GGSN:
means for reception of a request for establishment of a second end-to-end tunnel sent by the mobile station; GGSN node
means for obtaining from an AAA server authorization and GGSN node authentication information relating to said communication session and enabling the establishment of a second end-to-end tunnel GGSN node between said mobile station and said TTG gateway;
means for clearing down of said first end-to-end tunnel; GGSN node
means for establishment of said second end-to-end tunnel.
